(19) United States
(12) Patent Application Publication
(10) Pub. No.: US 2015/0009030 A1
(43) Pub. Date: Jan. 8, 2015

(54) SYSTEM FOR MONITORING STATUS

(71) Applicant: DELTA ELECTRONICS, INC., Taoyuan Hsien (TW)

(72) Inventor: Cheng-Yen SHIH, Taoyuan Hsien (TW)

(73) Assignee: DELTA ELECTRONICS, INC., Taoyuan Hsien (TW)

(21) Appl. No.: 14/264,632

(22) Filed: Apr. 29, 2014

(30) Foreign Application Priority Data
Jul. 5, 2013 (TW) 102124126

(51) Int. Cl. G08B 21/18

(52) U.S. Cl. CPC G08B 21/18
USPC 340/540

(57) ABSTRACT

A system for monitoring a status is provided. The system includes: a status-monitoring device, configured to monitor a status of at least one plant or an environment status surrounding the plant, and wirelessly output a status monitoring result signal including the status and the environment status; a status-information processing device, including: an information unit, configured to store growth-status information of the plant and environmental status information appropriate for the plant; a comparing unit, configured to compare the information in the information unit with the status monitoring result signal; and a transmission unit, configured to receive the status monitoring result signal and transmit a status-adjusting signal; and a status adjusting device, configured to adjust the environment status according to the status-adjusting signal.

### CROSS REFERENCE TO RELATED APPLICATIONS

The present application is based on, and claims priority from, Taiwan Application Serial Number 102124126, filed on Jul. 5, 2013, the invention of which is hereby incorporated by reference herein in its entirety.

### TECHNICAL FIELD

The present invention relates to a system for monitoring a status, and in particular relates to a system for monitoring an environmental status.

### BACKGROUND

The traditional method for monitoring environment status is to observe and take care of an object in the environment immediately by using one's eyes or personal experience. However, environmental change has a great influence on objects taken care of by the user, but it is not easy for the user to observe the environmental change. When the user observes the environmental change, the user may have missed a rescue opportunity and put the object in jeopardy. Therefore, how to effectively improve the problem is a very important issue.

### SUMMARY

A detailed description is given in the following embodiments with reference to the accompanying drawings.

Systems for monitoring a status are provided.

In one exemplary embodiment, the invention is directed to a system for monitoring a status, comprising: a status-monitoring device, configured to monitor a status of at least one plant or an environment status surrounding the plant, and wirelessly output a status monitoring result signal including the status and the environment status; a status-information processing device, comprising: an information unit, configured to store growth-status information of the plant and environmental status information appropriate for the plant; a comparing unit, configured to compare the information in the information unit with the status monitoring result signal; and a transmission unit, configured to receive the status monitoring result signal and transmit a status-adjusting signal; and a status adjusting device, configured to adjust the environment status according to the status-adjusting signal.

In one exemplary embodiment, the invention is directed to a system for monitoring a status, comprising: a status-monitoring device, configured to monitor a status of at least one organism or an environment status surrounding the organism, and wirelessly output a status monitoring result signal including the status and the environment status; a status-information processing device, comprising: an information unit, configured to store growth-status information of the organism and environmental status information appropriate for the organism; a comparing unit, configured to compare the information in the information unit with the status monitoring result signal; and a transmission unit, configured to receive the status monitoring result signal and transmit a status-adjusting signal; and a status adjusting device, configured to adjust the environment status according to the status-adjusting signal.

In one exemplary embodiment, the invention is directed to a system for monitoring a status, comprising: a status-monitoring device, configured to monitor a status of at least one object or an environment status surrounding the object, and wirelessly output a status monitoring result signal including the status and the environment status; a status-information processing device, comprising: an information unit, configured to store growth-status information of the object and environmental status information appropriate for the object; a comparing unit, configured to compare the information in the information unit with the status monitoring result signal; and a transmission unit, configured to receive the status monitoring result signal and transmit a status-adjusting signal; and a status adjusting device, configured to adjust the environment status according to the status-adjusting signal.

In one exemplary embodiment, the invention is directed to a system for monitoring a status, comprising: a status-monitoring device, configured to monitor a status of at least one object or an environment status surrounding the object, and wirelessly output a status monitoring result signal including the status and the environment status; a status-information processing device, configured to receive the status monitoring result signal, compare information stored in the status-information processing device with the status monitoring result signal and transmit a status-adjusting signal; and a status adjusting device, configured to adjust the environment status according to the status-adjusting signal.

In some embodiments, the status-information processing device is a network server, cloud device, personal computer, notebook or mobile device.

In some embodiments, the mobile device is a tablet, smart phone or other portable communication device.

In some embodiments, the status-information processing device further comprises a display unit, configured to display the status, the environment status, the growth status information, the environmental status information, a comparing result of the information and the status monitoring result signal or a suggestion of the comparing result.

In some embodiments, the state information processing apparatus further comprises an automatic processing unit, configured to provide the status-adjusting signal according to a suggestion of a comparing result of the information and the status monitoring result signal following a predetermined time after the status-information processing device receives the status monitoring signal.

In some embodiments, the state information processing apparatus further comprises an input unit, configured to provide a user to adjust the status-adjusting signal.

### DRAWINGS

The present invention can be more fully understood by reading the subsequent detailed description and examples with references made to the accompanying drawings, wherein:

FIG. 1 is a block diagram of a system for monitoring a status according to an embodiment of the present invention;

FIG. 2 is a flow diagram illustrating the method for monitoring a status according to an embodiment of the present invention;

FIG. 3 is a flow diagram illustrating the method for monitoring a status according to an embodiment of the present invention;

FIG. 4 is a schematic diagram illustrating the system for monitoring a plant status according to an embodiment of the present invention;

FIG. 5 is a block diagram of the plant status-monitoring device according to an embodiment of the present invention with reference to FIG. 4;

FIG. 6 is a schematic diagram illustrating the system for monitoring an organism's status used to monitor an aquatic environment according to an embodiment of the present invention;

FIG. 7 is a block diagram of the organism's status-monitoring device according to an embodiment of the present invention with reference to FIG. 6;

FIG. 8 is a schematic diagram illustrating the system for monitoring indoor air according to an embodiment of the present invention; and

FIG. 9 is a block diagram of the indoor air quality monitoring device according to an embodiment of the present invention with reference to FIG. 8.

### DETAILED DESCRIPTION

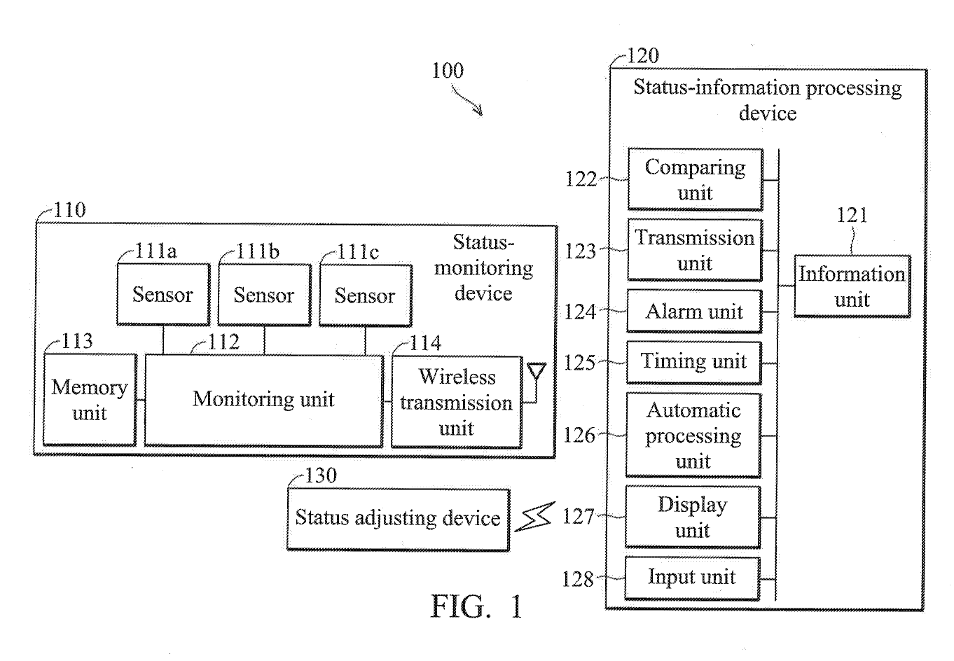

Several exemplary embodiments of the application are described with reference to FIGS. 1 through 9, which generally relate to a system for monitoring a status. It is to be understood that the following invention provides various different embodiments as examples for implementing different features of the application. Specific examples of components and arrangements are described in the following to simplify the present invention. These are, of course, merely examples and are not intended to be limiting. In addition, the present invention may repeat reference numerals and/or letters in the various examples. This repetition is for the purpose of simplicity and clarity and does not in itself dictate a relationship between the various described embodiments and/or configurations.

Embodiments described below illustrate systems for monitoring a status of the present invention.

FIG. 1 is a block diagram of a system 100 for monitoring a status according to an embodiment of the present invention. The system 100 comprises a status-monitoring device 110, a status-information processing device 120, and a status adjusting device 130. In the embodiment, the status-information processing device 120 may be a network server, cloud device, personal computer, notebook or mobile device, wherein the mobile device can be a tablet, smart phone or other portable communication device.

The status-monitoring device 110 is used to monitor at least a status of an object, or an environment status surrounding the object, and wirelessly output a status monitoring result signal including the status and the environment status to the status-information processing device 120. The status-monitoring device 110 may comprise a plurality of sensors (e.g., the sensors 111a, 111b and 111c), a monitoring unit 112, a memory unit 113 and a wireless transmission unit 114, wherein the sensors 111a, 111b and 111c, the monitoring unit 112, the memory unit 113 and the wireless transmission unit 114 are coupled to the status-monitoring device 110 respectively. In the embodiment, the number of sensors may be increased or decreased and not be limited to three. The sensors 111a, 111b and 111c are used to sense at least the status of the object, or the environment status surrounding the object to generate the status monitoring result signals. The monitoring unit 112 receives the status monitoring result signals transmitted from the sensor 111a, 111b and 111c, and store the status monitoring result signals in the memory unit 113. The monitoring unit 112 transmits the status monitoring result signals wirelessly to the status-information processing device 120 through a wireless transmission manner by the wireless transmission unit 114.

In another embodiment, the wireless transmission manner can be, for example, a local area network (LAN), Internet, Bluetooth, Wi-Fi, Wi-Fi Direct, Zigbee or another transmission manner.

In the embodiment, the status-information processing device 120 comprises an information unit 121, a comparing unit 122, a transmission unit 123, an alarm unit 124, a timing unit 125, an automatic processing unit 126, a display unit 127 and an input unit 128. The information unit 121 has the status information of the object, the environmental status information appropriate for the object, wherein the environmental status information appropriate for the object is a standard value for maintaining the environmental status for the object or other relevant information. The standard value and the relevant information can be a variety of environmental standard data announced by the government or the environmental standard values suggested by a research department, and can be stored in the information unit 121 in advance. In another embodiment, the user can also upload better environmental status data to the status-information processing device 120, so that other users can refer to the environmental status data to adjust the environmental status of the object.

After the status-monitoring device 110 transmits the status monitoring result signals to the status-information processing device 120, the comparing unit 122 further analyzes and compares the information in the information unit 121 with the status monitoring result signals, and determines whether the status monitoring result signals conform to the environmental status information appropriate for the object. When the comparing unit 122 determines that the status monitoring result signals do not conform to the environmental status information appropriate for the object (namely, the environmental status needs to be maintained), the alarm unit 124 may generate a warning signal to alert the user. In some embodiments, the warning signal may be a video or audio message.

When the comparing unit 122 determines that the status monitoring result signals conform to the environmental status information appropriate for the object, the comparing unit 122 stores the status monitoring result signals in the information unit 121. The user can retrieve the growth-status information of the object from the information unit 121 by the status-information processing device 120, and input a status-adjusting signal by the input unit 128. The status-information processing device 120 transmits the status-adjusting signal to the status adjusting device 130 by the transmission unit 123 through the Internet or the local area network. Finally, the status adjusting device 130 adjusts the environment status according to the adjusting signal to take appropriate measures for the environment status. In addition, the user can request the status-information processing device 120 to transmit a new status monitoring result signal according to a predetermined period.

When the alarm unit 124 generates the warning signal to inform the user, the timing unit 124 may count a warning time and determine whether the warning time has exceeded a specified time, wherein the specified time can be 0 or any time. When the warning time exceeds the specified time, it means that the user has not input the status-adjusting signal to the status-information processing device 120, and the automatic processing unit 126 provides the status-adjusting signal to the status adjusting device 130 according to a suggestion of a comparing result of the information. When the warning time does not exceed the specified time, the status-information processing device 120 may request the status-monitoring device 110 to transmit the new status monitoring result signal according to the predetermined period.

In another embodiment, when the alarm unit 124 generates the warning signal to inform the user, the user can input the status-adjusting signal to request the automatic processing unit 126 to take care of the object. The alarm unit 124 does not lift the alert signal until the status-monitoring device 110 monitors that the status monitoring result signal conforms to the environment status information appropriate for the object.

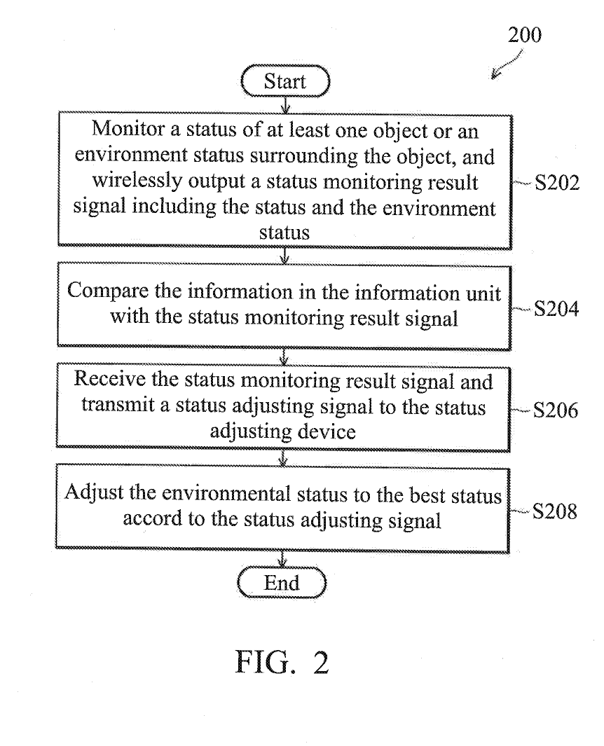

FIG. 2 is a flow diagram illustrating the method 200 for monitoring a status according to an embodiment of the present invention. In step S202, the status-monitoring device monitors a status of at least one object or an environment status surrounding the object, and wirelessly outputs a status monitoring result signal including the status and the environment status. In step S204, the status-information processing device compares the information in the information unit with the status monitoring result signal by the comparing unit. Then, in step S206, the status-information processing device receives the status monitoring result signal by the transmission unit and transmits a status-adjusting signal to the status adjusting device. Finally, in step S208, the status adjusting device adjusts the environmental status to the best status according to the status-adjusting signal.

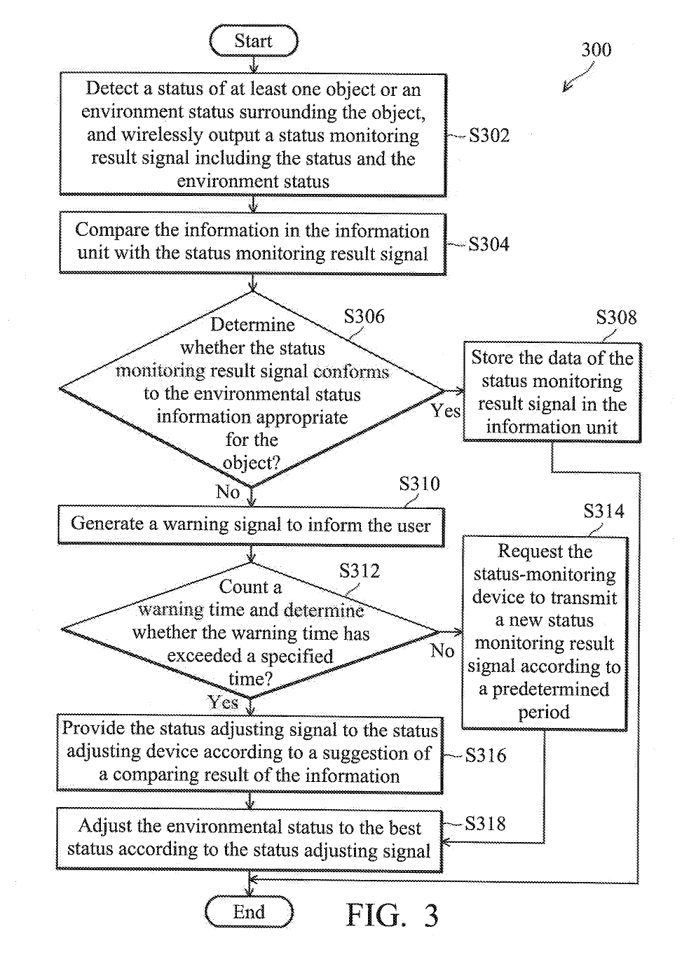

FIG. 3 is a flow diagram illustrating the method 300 for monitoring a status according to an embodiment of the present invention. In step S302, the status-monitoring device monitors a status of at least one object or an environment status surrounding the object, and wirelessly outputs a status monitoring result signal including the status and the environment status. In step S304, the status-information processing device compares the information in the information unit with the status monitoring result signal by the comparing unit. Then, in step S306, the comparing unit determines whether the status monitoring result signal conforms to the environmental status information appropriate for the object. When the comparing unit determines that the status monitoring result signal conforms to the environmental status information appropriate for the object (“Yes” in step S306), in step S308, the comparing unit stores the data of the status monitoring result signal in the information unit. When the comparing unit determines that the status monitoring result signal does not conform to the environmental status information appropriate for the object (“No” in step S306), in step S310, the alarm unit generates a warning signal to inform the user. Next, in step S312, the timing unit counts a warning time and determines whether the warning time has exceeded a specified time. When the warning time does not exceed the specified time (“No” in step S312), in step S314, the status-information processing device request the status-monitoring device to transmit a new status monitoring result signal according to a predetermined period. When the warning time has exceeded the specified time (“Yes” in step S312), in step S316, the automatic processing unit provides the status-adjusting signal to the status adjusting device according to a suggestion of a comparing result of the information. Finally, in step S318, the status adjusting device adjusts the environmental status to the best status according to the status-adjusting signal.

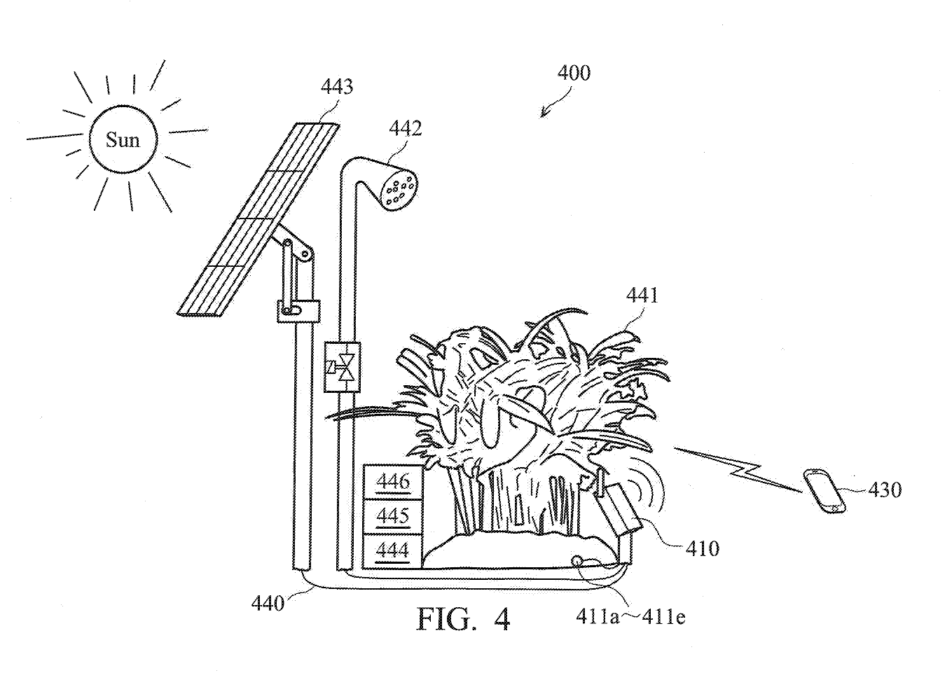

The system for monitoring a status may be a system for monitoring a plant status used to monitor an environment surrounding the plant. FIG. 4 is a schematic diagram illustrating the system 400 for monitoring a plant status according to an embodiment of the present invention. The system 400 for monitoring a plant status comprises a plant status-monitoring device 410, a status-information processing device 430 and a status adjusting device (not shown in FIG. 4).

The plant status-monitoring device 410 is installed in the proximity of the plant. The plant 441 can be any one of plants, flowers, grass and so on. The system 400 for monitoring a plant status further comprises a sprinkler 442, a solar panel 443, a connecting unit 440, a nutrient supply unit 444, an acid concentration control unit 445, and a temperature control unit 446.

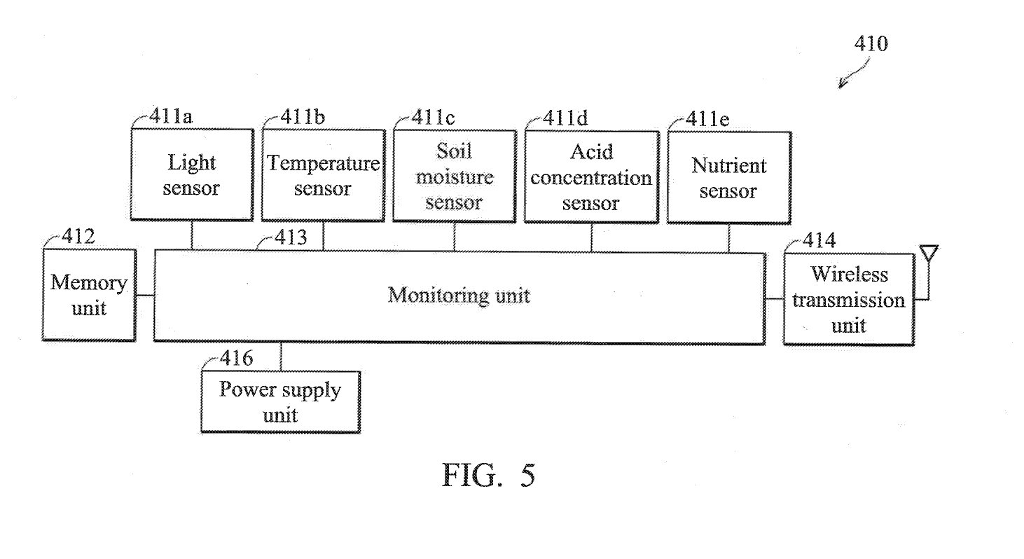

FIG. 5 is a block diagram of the plant status-monitoring device 410 according to an embodiment of the present invention with reference to FIG. 4. The plant status-monitoring device 410 is used to monitor a status of at least one plant or an environment status surrounding the plant, and wirelessly output a status monitoring result signal including the status and the environment status. The plant status-monitoring device 410 comprises a plurality of sensors (a light sensor 411a, a temperature sensor 411b, a soil moisture sensor 411c, an acid concentration sensor 411d and a nutrient sensor 411e), a memory unit 412, a monitoring unit 413, a wireless transmission unit 414 and a power supply unit 416, wherein the light sensor 411a, the temperature sensor 411b, the soil moisture sensor 411c, the acid concentration sensor 411d and the nutrient sensor 411e are installed in the proximity of the plant, and coupled to the monitoring unit 413. It should be noted that the kind and number of the sensors depend on the plant status and should not be limited to FIG. 5.

In the embodiment, the light sensor 411a, the temperature sensor 411b, the soil moisture sensor 411c, the acid concentration sensor 411d and the nutrient sensor 411e transmit a light measuring value, temperature measuring value, moisture measuring value, acid concentration measuring value and nutrient measuring value to the monitoring unit 413. The monitoring unit 413 stores the measuring values into the memory unit 412 of the plant status-monitoring device 410. The monitoring unit 413 transmits all status monitoring result signals to the status-information processing device 430 by the wireless transmission unit 414.

As shown in FIG. 1, the status-information processing device 430 comprises an information unit, a comparing unit, a transmission unit, an alarm unit, a timing unit, an automatic processing unit, a display unit and an input unit. The components are the same as the illustration of the embodiment described above, so the details related to the technologies of the system will be omitted.

It should be noted that when the comparing unit determines that the status monitoring result signals do not conform to the environmental status information appropriate for the plant and the user does not input the status-adjusting signal in the specified time, the automatic processing unit may analyze the status monitoring result signals and provide the status-adjusting signal to the status adjusting device according to the suggestion of the comparing result of the information. The status adjusting device adjusts the environment status according to the status-adjusting signal. For example, when the comparing unit determines that the amount of light monitored by the light sensor 411a does not conform the environmental status information of the light appropriate for the plant, the automatic processing unit may provide a light status-adjusting signal to the status adjusting device. After the status adjusting device receives the light status-adjusting signal, the status adjusting device controls the angle of the solar panel 443. The solar panel 443 can be used by a sunshading board to reduce the amount of light illuminating the plant 441. In some embodiments, the monitoring unit 410 may transfer the light collected from the solar panel 443 into the power of the power supply unit 416. In other embodiments, when the power of the power supply unit 416 is insufficient, the monitoring unit 410 may change and find the angle of the solar panel 443 to let the solar panel collect more light. It should be noted that the status adjusting device can use another method to control the amount of light without using the solar panel 443. In addition, if the light illuminating the plant is artificial light, the amount of light can be controlled by the artificial light.

In another example, when the comparing unit determines that the soil moisture monitored by the soil moisture sensor 411c does not conform to the soil moisture environmental status information appropriate for the plant, the automatic processing unit may transmit the status-adjusting signal to the status adjusting device. After the status adjusting device receives the status-adjusting signal, the status adjusting device may control the amount of water supplied by the sprinkler 442 to reduce or increase the soil moisture of the plant 441. In another example, when the comparing unit determines that the nutrient monitored by the nutrient sensor 411e do not conform to the nutrient environmental status information appropriate for the plant, the automatic processing unit may transmit the nutrient adjusting signal to the status adjusting device. After the status adjusting device receives the nutrient adjusting signal, the status adjusting device may control the nutrient supply unit 444 to add fertilizer for increasing the nutrients for the plant 441.

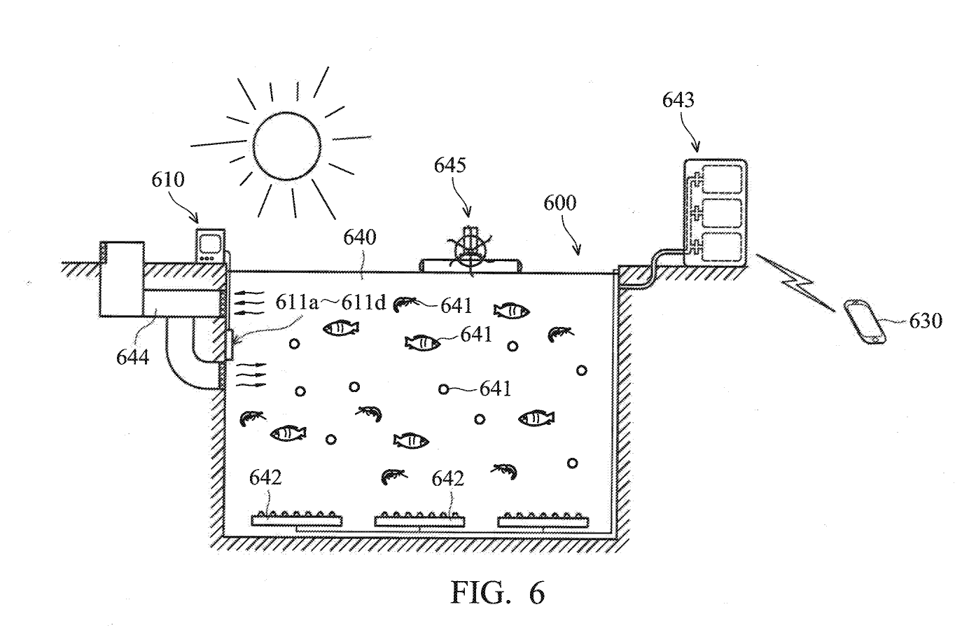

In another embodiment, the system for monitoring a status may be a system for monitoring an organism's status used to monitor an aquatic environment. FIG. 6 is a schematic diagram illustrating the system 600 for monitoring an organism's status used to monitor an aquatic environment according to an embodiment of the present invention. The system 600 for monitoring an organism's status comprises an organism's status-monitoring device 610, a status-information processing device 630 and a status adjusting device (not shown in FIG. 6).

The organism's status-monitoring device 610 is installed in a pond 640. A variety of fish, shrimp, shellfish, algae, aquatic plants and other organisms 641 can be farmed in the pond 640. The pond 640 may be mounted a lighting unit 642, a nutrient supply unit 643, a filter unit 644 and a water pump 645.

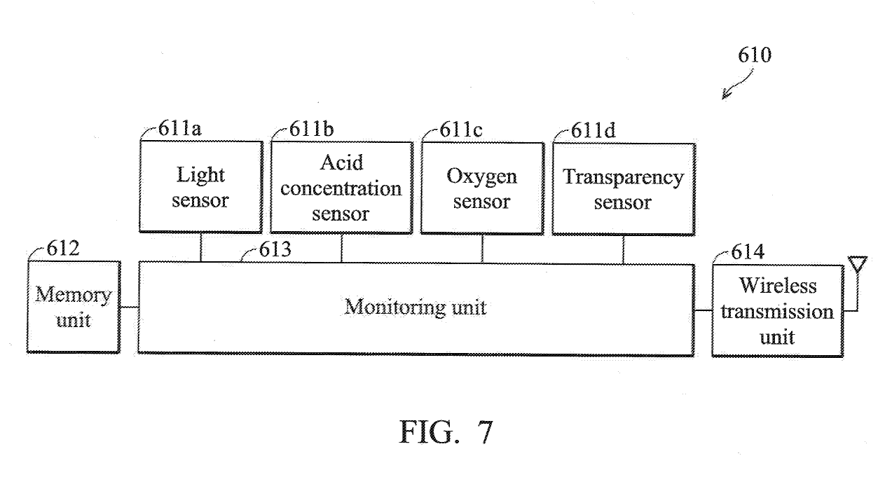

FIG. 7 is a block diagram of the organism's status-monitoring device 610 according to an embodiment of the present invention with reference to FIG. 6. The organism's status-monitoring device 610 is used to monitor the status of at least one organism or an environment status surrounding the organism, and wirelessly output a status monitoring result signal including the status and the environment status. The organism's status-monitoring device 610 comprises a plurality of sensors (a light sensor 611a, an acid concentration sensor 611b, an oxygen sensor 611c and a transparency sensor 611d), a memory unit 612, a monitoring unit 613, a wireless transmission unit 614 and a power supply unit 616, wherein the light sensor 611a, the acid concentration sensor 611b, the oxygen sensor 611c and the transparency sensor 611d are installed in the pond 640, and coupled to the monitoring unit 613. It should be noted that the kind and number of the sensors depend on the organism's status and should not be limited to FIG. 7.

In the embodiment, the light sensor 611a, the acid concentration sensor 611b, the oxygen sensor 611c and the transparency sensor 611d transmit a light measuring value, an acid concentration measuring value, an oxygen measuring value and a transparency measuring value to the monitoring unit 613. The monitoring unit 613 stores the measuring values into the memory unit 612 of the organism's status-monitoring device 610. The monitoring unit 613 transmits all status monitoring result signals to the status-information processing device 630 by the wireless transmission unit 614.

As shown in FIG. 1, the status-information processing device 630 comprises an information unit, a comparing unit, a transmission unit, an alarm unit, a timing unit, an automatic processing unit, a display unit and an input unit. The components are the same as the illustration of the embodiment described above, so the details related to the technologies of the system will be omitted.

It should be noted that when the comparing unit determines that the status monitoring result signals do not conform to the environmental status information appropriate for the organism and the user does not input the status-adjusting signal in the specified time, the automatic processing unit may analyze the status monitoring result signals and provide the status-adjusting signal to the status adjusting device according to the suggestion of the comparing result of the information. The status adjusting device adjusts the environment status according to the status-adjusting signal. For example, when the comparing unit determines that the amount of oxygen monitored by the oxygen sensor 611c does not conform the environmental status information of the oxygen appropriate for the organism, the automatic processing unit may provide an oxygen adjusting signal to the status adjusting device. After the status adjusting device receives the oxygen adjusting signal, the status adjusting device may control the water pump 645 to pump air into the pond 640 for increasing oxygen and increasing the flow of water.

In another example, when the comparing unit determines that the transparency monitored by the transparency sensor 611d does not conform to the transparency environmental status information appropriate for the organism, the automatic processing unit may provide a transparency adjusting signal to the status adjusting device. After the status adjusting device receives the transparency adjusting signal, the status adjusting device may control the filter unit 644 to filter the water.

In another embodiment, the system for monitoring a status may be a system for monitoring indoor air.

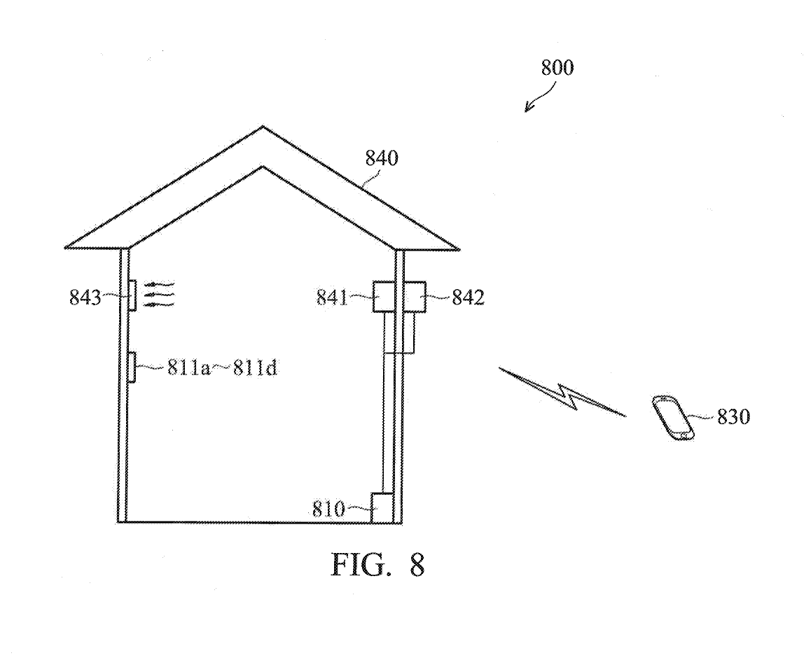

In another embodiment, the system for monitoring a status may be a system for monitoring indoor air used to monitor indoor air quality (IAQ). FIG. 8 is a schematic diagram illustrating the system 800 for monitoring indoor air according to an embodiment of the present invention. The system 800 for monitoring indoor air comprises an indoor air quality monitoring device 810, a status-information processing device 830 and a status adjusting device (not shown in FIG. 8).

The indoor air quality monitoring device 810 is installed in a house 840. An indoor unit 841 of a split-type air conditioner, an outdoor unit 842 of the split-type air conditioner and an air-extractor 843.

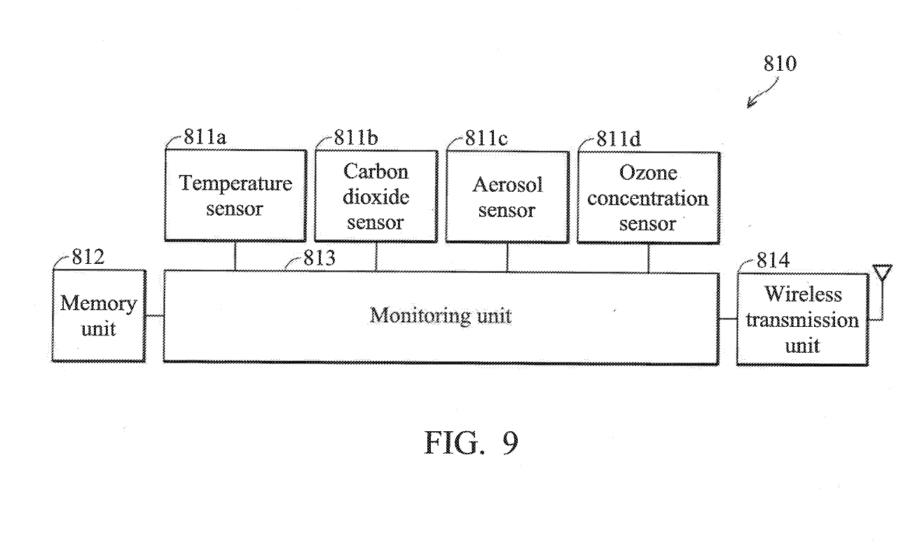

FIG. 9 is a block diagram of the indoor air quality monitoring device 810 according to an embodiment of the present invention with reference to FIG. 8. The indoor air quality monitoring device 810 comprises a plurality of sensors (a temperature sensor 811a, a carbon dioxide sensor 811b, an aerosol sensor 811c and an ozone concentration sensor 811d), a memory unit 812, a monitoring unit 813, a wireless transmission unit 814 and a power supply unit 816, wherein the temperature sensor 811a, the carbon dioxide sensor 811b, the aerosol sensor 811c and the ozone concentration sensor 811d are installed in the house 840, and coupled to the monitoring unit 813. It should be noted that the kind and number of the sensors depend on the indoor air quality and should not be limited to FIG. 9.

In the embodiment, the temperature sensor 811a, the carbon dioxide sensor 811b, the aerosol sensor 811c and the ozone concentration sensor 811d transmit a temperature measuring value, the carbon dioxide measuring value, the aerosol measuring value and the ozone concentration measuring value to the monitoring unit 813. The monitoring unit 813 stores the measuring values into the memory unit 812 of the indoor air quality monitoring device 810. The monitoring unit 813 transmits all status monitoring result signals to the status-information processing device 830 by the wireless transmission unit 814.

As shown in FIG. 1, the status-information processing device 830 comprises an information unit, a comparing unit, a transmission unit, an alarm unit, a timing unit, an automatic processing unit, a display unit and an input unit. The components are the same as the illustration of the embodiment described above, so the details related to the technologies of the system will be omitted.

It should be noted that when the comparing unit determines that the status monitoring result signals do not conform to the environmental status information and the user does not input the status-adjusting signal in the specified time, the automatic processing unit may analyze the status monitoring result signals and provide the status-adjusting signal to the status adjusting device according to the suggestion of the comparing result of the information. The status adjusting device adjusts the environment status according to the status-adjusting signal. For example, when the comparing unit determines that the amount of aerosol monitored by the aerosol sensor 811c does not conform the environmental status information of the aerosol, the automatic processing unit may provide an aerosol adjusting signal to the status adjusting device. After the status adjusting device receives the aerosol adjusting signal, the status adjusting device may control the air-extractor 843 to extract the air in the house to decrease the aerosol in the air.

In another example, when the comparing unit determines that the temperature monitored by the temperature sensor 811a does not conform to the temperature environmental status information, the automatic processing unit may provide a temperature adjusting signal to the status adjusting device. After the status adjusting device receives the temperature adjusting signal, the status adjusting device may control the indoor unit 841 of the split-type air conditioner to adjust the temperature.

In summary, the system for monitoring a status of the present invention uses a status-monitoring device at a local location and a status-information processing device at a remote location to maintain better environmental status. The user can use the method and system for monitoring a status to monitor immediately, monitor the environmental status and control the related device for taking care of the environment.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for monitoring a status, comprising:
a status-monitoring device, configured to monitor a status of at least one plant or an environment status surrounding the plant, and wirelessly output a status monitoring result signal including the status and the environment status;
a status-information processing device, comprising:
an information unit, configured to store growth-status information of the plant and environmental status information appropriate for the plant;
a comparing unit, configured to compare the information in the information unit with the status monitoring result signal; and
a transmission unit, configured to receive the status monitoring result signal and transmit a status-adjusting signal; and
a status adjusting device, configured to adjust the environment status according to the status-adjusting signal.

2. The system for monitoring a status as claimed in claim 1, wherein the status-information processing device further comprises a display unit, configured to display the status, the environment status, the growth status information, the environmental status information, a comparing result of the information and the status monitoring result signal or a suggestion of the comparing result.

3. The system for monitoring a status as claimed in claim 1, wherein the state information processing apparatus further comprises an automatic processing unit, configured to provide the status-adjusting signal according to a suggestion of a comparing result of the information and the status monitoring result signal following a predetermined time after the status-information processing device receives the status monitoring signal.

4. The system for monitoring a status as claimed in claim 1, wherein the state information processing apparatus further comprises an input unit, configured to provide a user to adjust the status-adjusting signal.

5. A system for monitoring a status, comprising:
a status-monitoring device, configured to monitor a status of at least one organism or an environment status surrounding the organism, and wirelessly output a status monitoring result signal including the status and the environment status;
a status-information processing device, comprising:
an information unit, configured to store growth-status information of the organism and environmental status information appropriate for the organism;
a comparing unit, configured to compare the information in the information unit with the status monitoring result signal; and
a transmission unit, configured to receive the status monitoring result signal and transmit a status-adjusting signal; and
a status adjusting device, configured to adjust the environment status according to the status-adjusting signal.

6. The system for monitoring a status as claimed in claim 5, wherein the status-information processing device is a network server, cloud device, personal computer, notebook or mobile device.

7. The system for monitoring a status as claimed in claim 5, wherein the status-information processing device further comprises a display unit, configured to display the status, the environment status, the growth status information, the environmental status information, a comparing result of the information and the status monitoring result signal or a suggestion of the comparing result.

8. The system for monitoring a status as claimed in claim 5, wherein the state information processing apparatus further comprises an automatic processing unit, configured to provide the status-adjusting signal according to a suggestion of a comparing result of the information and the status monitoring result signal following a predetermined time after the status-information processing device receives the status monitoring signal.

9. The system for monitoring a status as claimed in claim 5, wherein the state information processing apparatus further comprises an input unit, configured to provide a user to adjust the status-adjusting signal.

10. A system for monitoring a status, comprising:
a status-monitoring device, configured to monitor a status of at least one object or an environment status surrounding the object, and wirelessly output a status monitoring result signal including the status and the environment status;
a status-information processing device, comprising:
an information unit, configured to store growth-status information of the object and environmental status information appropriate for the object;
a comparing unit, configured to compare the information in the information unit with the status monitoring result signal; and
a transmission unit, configured to receive the status monitoring result signal and transmit a status-adjusting signal; and
a status adjusting device, configured to adjust the environment status according to the status-adjusting signal.

11. The system for monitoring a status as claimed in claim 10, wherein the status-information processing device is a network server, cloud device, personal computer, notebook or mobile device.

12. The system for monitoring a status as claimed in claim 10, wherein the status-information processing device further comprises a display unit, configured to display the status, the environment status, the growth status information, the environmental status information, a comparing result of the information and the status monitoring result signal or a suggestion of the comparing result.

13. The system for monitoring a status as claimed in claim 10, wherein the state information processing apparatus further comprises an automatic processing unit, configured to provide the status-adjusting signal according to a suggestion of a comparing result of the information and the status monitoring result signal following a predetermined time after the status-information processing device receives the status monitoring signal.

14. The system for monitoring a status as claimed in claim 10, wherein the state information processing apparatus further comprises an input unit, configured to provide a user to adjust the status-adjusting signal.

15. A system for monitoring a status, comprising:
a status-monitoring device, configured to monitor a status of at least one object or an environment status surrounding the object, and wirelessly output a status monitoring result signal including the status and the environment status;
a status-information processing device, configured to receive the status monitoring result signal, compare information stored in the status-information processing device with the status monitoring result signal and transmit a status-adjusting signal; and
a status adjusting device, configured to adjust the environment status according to the status-adjusting signal.

16. The system for monitoring a status as claimed in claim 15, wherein the status-information processing device is a network server, cloud device, personal computer, notebook or mobile device.

17. The system for monitoring a status as claimed in claim 16, wherein the mobile device is a tablet, smart phone or other portable communication device.

18. The system for monitoring a status as claimed in claim 15, wherein the status-information processing device further comprises a display unit, configured to display the status, the environment status, the growth status information, the environmental status information, a comparing result of the information and the status monitoring result signal or a suggestion of the comparing result.

19. The system for monitoring a status as claimed in claim 15, wherein the state information processing apparatus further comprises an automatic processing unit, configured to provide the status-adjusting signal according to a suggestion of a comparing result of the information and the status monitoring result signal following a predetermined time after the status-information processing device receives the status monitoring signal.

20. The system for monitoring a status as claimed in claim 15, wherein the state information processing apparatus further comprises an input unit, configured to provide a user to adjust the status-adjusting signal.
